(19) United States
(12) Patent Application Publication
(10) Pub. No.: US 2017/0228531 A1
(43) Pub. Date: Aug. 10, 2017

(54) PASSWORD ENTRY THROUGH TEMPORALLY-UNIQUE TAP SEQUENCE

(71) Applicant: Reza RAJI, Menlo Park, CA (US)

(72) Inventor: Reza RAJI, Menlo Park, CA (US)

(21) Appl. No.: 15/264,743

(22) Filed: Sep. 14, 2016

Related U.S. Application Data
(63) Continuation-in-part of application No. 14/852,914, filed on Sep. 14, 2015, now abandoned.

(51) Int. Cl. G06F 21/35; G06N 99/00

(52) U.S. Cl. CPC G06F 21/35; G06N 99/005

(57) ABSTRACT

Embodiments replace a password with a tap sequence. Systems and methods receive tapping signals at an input sensor. A learned sequence of taps and correlation factors is accessed in a database. Tapping is detected on an adjacent surface by comparing the tapping signals received from the input sensor to the learned sequence and the correlation factors. Access to a secure system is automatically enabled when a match is identified between the detected tapping and the learned sequence.

### RELATED APPLICATION

This application is a continuation in part of U.S. patent application Ser. No. 14/852,914, filed Sep. 14, 2015, which is a continuation of U.S. patent application Ser. No. 14/160,764, filed Jan. 22, 2014, which claims the benefit of U.S. Patent Application No. 61/755,378, filed Jan. 22, 2013.

### TECHNICAL FIELD

Embodiments described herein relate to processing systems and, more particularly, to systems and methods of securely controlling access to processing systems.

### BACKGROUND

Character-based passwords are used by web sites, software programs, financial institutions (e.g. ATMs) and mobile devices to restrict access to sensitive or private data. Typically these passwords are a combination of letters, numbers and/or special characters that only the user or owner is aware of and must somehow be memorized and recalled for use when access to the private information or web site is needed. An issue with the conventional character passwords is that passwords offering a relatively higher level of security include more random sequences of characters, numbers and/or symbols and are therefore harder to remember. A further issue is that every user must remember the password either by recording it somewhere, which increases the risk of password exposure, or by trying to memorize it, which is prone to errors or failure by the user when trying to recall the password. Moreover, a password can be easily visually observed and “stolen” by third parties when the user is entering them via a keyboard, keypad, and/or other input/output (I/O) device.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIG. 1 is a block diagram of a host device processing system that includes the tap sequencing system, under an embodiment.

FIG. 2 depicts the musical notes of an example sequence.

FIG. 3 is a flow diagram for tap sequencing, under an embodiment.

### DETAILED DESCRIPTION

Embodiments describe a new way for users to create and use a “password” to gain access to a system or device by leveraging a human's natural ability to easily and faithfully recall temporal rhythms (e.g., music) rather than having to memorize words and/or random characters. Further, the processing makes use of information including the user tapping signature or fingerprint, which comprises extracting, characterizing and reliably detecting the unique “human” attributes a tapped song or piece of music as it is “played” by a person.

Embodiments described herein provide “tap sequencing” as a security method that simplifies user access to private or sensitive data, websites, software and/or any system or component making use of secured access techniques. The tap sequencing includes the use of uniquely spaced user taps, rather than the traditional mechanism of password character entry. Rather than a unique sequence of characters entered through a keyboard or keypad, the tap sequencing described herein relies on the user entering a specific sequence of taps via a button, key and/or other I/O device. Consequently, the tapping entry does not require a full QWERTY keyword and as such is advantageous for smaller devices (e.g., mobile telephones, tablet devices, etc.) or situations where use of a keyboard is not desirable (e.g. bank ATM machines). Thus, the tap sequencing leverages the brain's natural ability to memorize and recall music and rhythm much more easily than words, letters and numbers.

The term “tap” or “tapping” is used herein to include tap, strike, knock, rap, pat, thump, and action terms of similar import. Tapping generally includes contact between someone's hand and a surface of another object, where the contact may include contacting the surface more than one time. For example, the tapping may include time-varying contact with a surface expressed as a unique pattern or rhythm of movement over an interval of time. The pattern or rhythm may include tapping the surface a varying number of times, in different locations, with varying intensity, and in particular rhythms but is not so limited. In addition to the pattern or rhythm of the actual taps or strikes, the tapping also includes a “fingerprint” or “signature” that is the individual attributes or style of the tapping of a particular user, as no two users are going to tap the same musical sequence the same exact way. As such, the embodiments herein extract, characterize and reliably detect the “human” attributes or style embedded in the unique way each individual taps a particular sequence.

In the following description, numerous specific details are introduced to provide a thorough understanding of, and enabling description for, embodiments of the tap sequence system. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

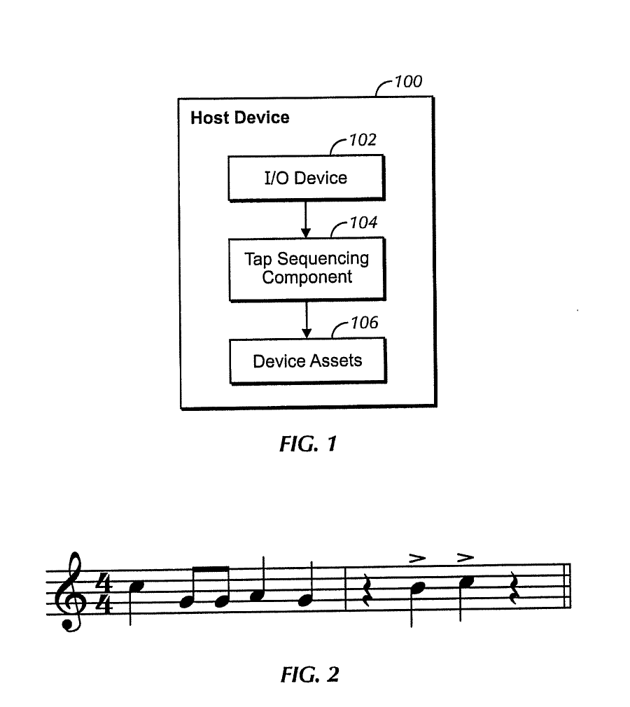

FIG. 1 is a block diagram of a host device processing system that includes the tap sequencing system 100, under an embodiment. The tap sequencing system comprises a tap sequencing component 104 coupled to an I/O device and/or a sensor device 102, and to device assets 106 that include one or more of memory, applications, and software to name a few. The tap sequencing component 104 of an embodiment, which is a signal processor or signal processing component, includes an algorithm, program and/or application running on a processor, but it is not so limited.

The tap sequencing component 104 receives through the I/O device 102 of a host device the tap sequence for a particular user of the host device. The algorithm detects, analyzes and compares a user-entered series of taps against a stored “key” that was originally entered by the user during the “password” setting process. A system-defined set of “correlation factors” is used to determine if the user entry is “close enough” to the stored key, based on one or more of the variables described herein, and if so the entry is deemed valid and the system permits user access. The stored key and the correlation factors of an embodiment are stored in at least one of memory resident on the host device and memory coupled to the host device.

The tap sequencing information is transferred to the tap sequencing component 104 from the I/O device 102 using sensor signals. Upon receipt of the sensor signals, the tap sequencing component 104 generally performs processing or calculations that distinguish between signals caused by a user tapping on an adjacent surface and noise and/or other extraneous signals. The noise and other extraneous signals include inadvertent vibrations caused by the user or other nearby persons as well as noise of the local environment.

The tap sequencing component of an embodiment identifies or determines numerous parameters of the tapping including the location, intensity, rhythm, and repetition of the tapping. This determination is made for example using at least one set of correlations factors described herein, also referred to as a tap sequencing model. The tap sequencing model characterizes and describes the different ways a user can tap a particular sequence (e.g., intensity, rhythm, pattern, etc.). The tap sequencing component therefore analyzes the tap sequencing signals and identifies a tapping signature (also referred to as an “acoustic signature”) that corresponds to the detected tapping. The tap sequencing component uses information of the identified tapping signature to determine if the correct sequence of taps has been entered in order to grant access to a connected system.

The sequence of taps of an embodiment is “learned” by the system during a “password” setting process similar to a system learning a character-based password. However the series of taps represents a specific tune, song or rhythm with which the user is already familiar. For example, in response to a password request on a mobile device (e.g., mobile telephone table device, etc.), the user can enter the following sequence of taps into the phone's screen:
TAP...TAP.TAP.TAP..TAP......TAP..TAP
   The dots in between the taps represent elapsed time; in this example the length of each tap is the same, but the embodiment is not so limited.

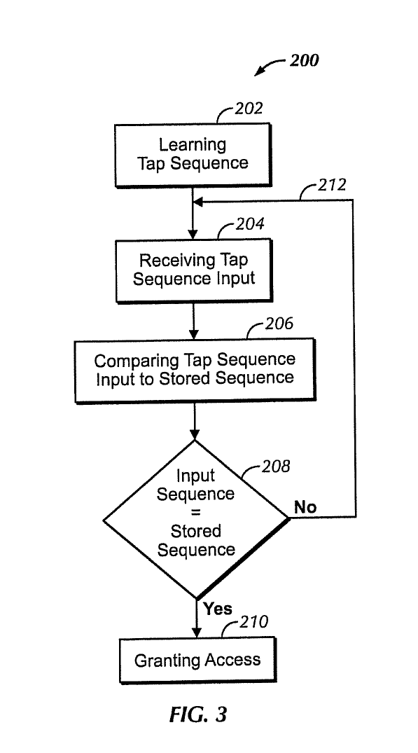

FIG. 2 is an example sequence of a tapped version of the popular song “Shave and a Haircut” as shown with musical notation. Note that the actual notes of a chosen song are irrelevant. However, the relative spacing between the notes as well as the relative length of each note is important. Furthermore, the length of the sequence input by a user is not limited to any particular number of notes of elapsed time but is instead a matter of user selection.

FIG. 3 is a flow diagram for tap sequencing 200, under an embodiment. Operation begins with learning of the tap sequence 202 that, in an embodiment, comprises a user selecting or entering a tap sequence, and confirming the tap sequence. The learning is accomplished by each user training the application, and the training includes dynamic “training” that includes, for example, analyzing the same tap sequence from a user over time (e.g., consecutive, over a period of days, etc.). Subsequent to programming of the device with the tap sequence, a user accesses the device by entering the tap sequence 204 at an I/O component of the device. The tap sequencing component detects the tap sequence, and analyzes 206 the detected tap sequence using the correlation factors. When the received tap sequence is determined to be the stored sequence 208, the user is granted access 210 to the host device; otherwise, access to the host device is denied 212.

The series of taps can be entered in a range of speeds without affecting the integrity or reliability of access. More specifically, parameters are available to the system to fine-tune the access sensitivity, where the parameters of an embodiment include one or more of variability in the overall speed or tempo of the entry, variability of the relative tap hold durations (if not tap edge-based), variability of the relative spaces between the taps, and minimum and maximum length of the entry (either based on the number of taps or the length of time). As an example, the application or component of an embodiment uses the following variables and/or constants:

const int maxTaps=15; //maximum number of taps accepted

const int arraySize=maxTaps−1; //length of tap array (time deltas between taps)

const int cFactor=90; //delta comparison correlation factor; (0=NO correlation window; 100=+−50% variance)

const int maxTimeOut=1500; //timeout in ms for no taps

const int debounceDelay=20; //button debounce delay in ms

volatile int buttonState=0; //variable for reading the pushbutton status

int i=0; //local array counter

volatile int tapCount=0; //there are (arraySize+1) taps

int learnMode=0; //System now learning a new tap key sequence

volatile unsigned long tapArray[arraySize]; //input tap timing array (ms for each tap)

unsigned long keyArray[arraySize]; //tap key timing array (ms for each tap)—this is the stored key

unsigned long testHighArray[arraySize]; //array for high end of the comparison range

unsigned long testLowArray[arraySize]; //array for low end of the comparison range

volatile unsigned long deltaTime=0; //delta time between taps

volatile unsigned long lastTimeSnap=0; //store last tap time for comparison with next

volatile unsigned long timeSnap=0; //current tap time snapshot

float tempoScaleFactor=0; //this is the ratio of the entered tap tempo compared to the key's tempo

The tap sequence of an embodiment can be very unique to the user as he/she can chose amongst a wide range of tunes, songs or rhythms that's personal to them. In addition to the selected tune, song or rhythm selected, the tapping is personal because it includes a “fingerprint” or “signature” that includes the attributes of the individual's style of tapping the selected notes. Similar to fingerprints, the tapping of each individual will have a style or “signature” meaning that no two users are going to tap the same sequence exactly the same exact way. It is therefore much more difficult for anyone else to try to guess the tap sequence than it would be a traditional character-based password. Further, the tap sequence can be easily remembered as it generally is a song or rhythm that the user is already very familiar with, likes and can readily recall on demand without having to deal with a cumbersome sequence of characters or words.

Embodiments, in detecting and processing the subtle “fingerprint” for each user, provide additional security beyond just detecting a sequence of taps. Embodiments include adjustable correlation factor(s) for varying the entry analysis sensitivity (relative tempo accuracy). Further, correlation factor(s) can be dynamically adjusted for the user based on their unique “personality” (e.g., age, tap style, tap sequence variance, etc.). The processing is tempo-insensitive through smart-scaling (separate from the correlation factor). Additionally, style insensitivity is provided through tap “edge” detection (insensitive to holding down a tap). Also, tap velocity (force) sensitivity of an embodiment offers additional security as another attribute of a signature.

Therefore, in addition to a selected sequence of taps, additional security is realized under the embodiments because the tapping of a particular tune is somewhat unique to an individual. The “finger print” on the tapping style allows for even greater security since in most if not all cases, any two people would tap the same tune slightly differently. Also, to an outside observer, the tapping process is much harder to identify and “steal” as the user appears to be doing nothing more than tapping his or her finger on a phone or key to a song or rhythm that is only in their head. Though it is technically possible to record the tapping process and analyze through playback, the embodiments herein provide a much more secure method than entering characters on a keyboard.

Additionally, the tap sequence is less prone to hacking, as the “key” stored at the host device is not a sequence of characters and/or number but rather a set of mathematical numbers that define the tapping signature. This effectively represents an infinite number of possibilities and thus has a relatively low probability of being hacked through rapid trial-and-error of different codes.

Computer systems and networks suitable for use with the tap sequencing embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network as a component with tap sequencing may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANs, Internets, and computers. The computers may serve as servers, clients, or a combination thereof.

The tap sequencing system can be a component of a single system, multiple systems, and/or geographically separate systems. The tap sequencing system can also be a subcomponent or subsystem of a single system, multiple systems, and/or geographically separate systems. The tap sequencing system can be coupled to one or more other components (not shown) of a host system or a system coupled to the host system.

One or more components of the tap sequencing system and/or a corresponding system or application to which the tap sequencing system is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that includes the tap sequencing system can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the tap sequencing system and corresponding systems and methods is not intended to be exhaustive or to limit the systems and methods to the precise forms disclosed. While specific embodiments of, and examples for, the tap sequencing system and corresponding systems and methods are described herein for illustrative purposes, various equivalent modifications are possible within the scope of the systems and methods, as those skilled in the relevant art will recognize. The teachings of the tap sequencing system and corresponding systems and methods provided herein can be applied to other systems and methods, not only for the systems and methods described above. The elements and acts of the various embodiments described above can be combined to provide further embodiments. These and other changes can be made to the tap sequencing system and corresponding systems and methods in light of the above detailed description.

What is claimed is:

1. A system comprising:
an input sensor;
a database including a learned sequence of taps and correlation factors, wherein the correlation factors include a tapping signature comprising at least one personal style attribute of each user corresponding to the sequence of taps; and
a processing component coupled to the input sensor and the database, wherein the processing component detects tapping on an adjacent surface by comparing signals received from the input sensor to the learned sequence and the correlation factors, wherein the processing component automatically enables access to a secure system coupled to the processing component when the processing component identifies a match between the detected tapping and the learned sequence.

2. The system of claim 1, comprising a communication system configured to transfer signals from the input sensor to the processing component, wherein the communication system is at least one of a wireless communication system, a wired communication system, and a hybrid wireless and wired communication system.

3. The system of claim 1, wherein the learned sequence is a password that controls access to the secure system.

4. The system of claim 1, wherein the processing component identifies the match by applying at least one of the correlation factors to parameters of the detected tapping.

5. The system of claim 4, wherein the parameters comprise a number of taps, a length of each tap, an intensity of each tap, and relative time lapse between at least two taps.

6. The system of claim 1, wherein the device initiates control by generating a control signal for use in accessing the secure system.

7. The system of claim 1, wherein the learned sequence is received through the input sensor.

8. A method comprising:
receiving tapping signals at an input sensor;
accessing a learned sequence of taps and correlation factors in a database, wherein the correlation factors include a tapping signature comprising at least one personal style attribute of each user corresponding to the sequence of taps; and
detecting tapping on an adjacent surface by comparing the tapping signals received from the input sensor to the learned sequence and the correlation factors; and
automatically enabling access to a secure system when a match is identified between the detected tapping and the learned sequence.

9. The method of claim 8, comprising transferring the tapping signals from the input sensor to the processing component via at least one of a wireless communication system, a wired communication system, and a hybrid wireless and wired communication system.

10. The method of claim 8, wherein the learned sequence is a password that controls access to the secure system.

11. The method of claim 8, comprising identifying the match by applying at least one of the correlation factors to parameters of the detected tapping.

12. The method of claim 11, wherein the parameters comprise a number of taps, a length of each tap, an intensity of each tap, and relative time lapse between at least two taps.

13. The method of claim 8, comprising initiating control by generating a control signal for use in accessing the secure system.

14. The method of claim 8, comprising receiving the learned sequence via the input sensor.
